(19) United States
(12) Patent Application Publication
(10) Pub. No.: US 2024/0184610 A1
(43) Pub. Date: Jun. 6, 2024

(54) PATH SELECTION METHOD BASED ON AN ACTIVE-ACTIVE CONFIGURATION FOR A HYPERCONVERGED INFRASTRUCTURE STORAGE ENVIRONMENT

(71) Applicant: VMware, Inc., Palo Alto, CA (US)

(72) Inventors: Yang YANG, Shanghai (CN); Sixuan YANG, Shanghai (CN); Zhaohui GUO, Shanghai (CN); Jian ZHAO, Shanghai (CN); Jin FENG, Shanghai (CN); Zhou HUANG, Shanghai (CN); Jianxiang ZHOU, Shanghai (CN)

(73) Assignee: VMware, Inc., Palo Alto, CA (US)

(21) Appl. No.: 18/073,525

(22) Filed: Dec. 1, 2022

(51) Int. Cl. G06F 9/455

(52) U.S. Cl. CPC G06F 9/45558; G06F 9/45545; G06F 2009/4557; G06F 2009/45583; G06F 2009/45591

(57) ABSTRACT

For a distributed storage system that has an active-active configuration for hosts and which uses an Internet small computer system interface (iSCSI) protocol, techniques are provided to identify/select a plurality of paths to a target. An active optimized path is selected for a host that is an object owner, and an active non-optimized path is selected for a host that is a component owner. The selection of the optimized path for a host is further based on whether that host has sufficient processor and memory resources to service input/output for the target. A standby path is selected for any other host that is neither an object owner or a component owner. The selected paths are provided to an initiator so as to enable the initiator to choose at least one of the paths to access the target for the input/output.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A software-defined approach may be used to create shared storage for VMs and/or for some other types of entities, thereby providing a distributed storage system in a virtualized computing environment. Such software-defined approach virtualizes the local physical storage resources of each of the hosts and turns the storage resources into pools of storage that can be divided and accessed/used by VMs or other types of entities and their applications. The distributed storage system typically involves an arrangement of virtual storage nodes or logical storage units that communicate data with each other and with other devices.

One type of virtualized computing environment that uses a distributed storage system is a hyperconverged infrastructure (HCI) environment, which combines elements of a traditional data center: storage, compute, networking, and management functionality. An HCI storage environment may be implemented and managed by using, for example, the vSphere suite of virtualization software provided by VMware, Inc. of Palo Alto, California or other virtualization products provided by others.

Such virtualization software of VMware, Inc. (or other analogous virtualization software/products by other providers) may include as examples: (1) an ESXi hypervisor that implements virtual machines (VMs) on physical hosts, (2) vSAN software that aggregates local storage to form a shared datastore for a cluster of ESXi hosts, and (3) a vCenter Server that centrally provisions and manages virtual datacenters, VMs, ESXi hosts, clusters, datastores, and virtual networks. The vSAN software may be implemented as part of the ESXi hypervisor software.

The vSAN software uses the concept of a disk group as a container for solid-state drives (SSDs) and non-SSDs, such as hard disk drives (HDDs). On each host (node) in a vSAN cluster, the local drives are organized into one or more disk groups. Each disk group includes one SSD that serves as read cache and write buffer (e.g., a cache tier), and one or more SSDs or non-SSDs that serve as permanent storage (e.g., a capacity tier). The aggregate of the disk groups from all the nodes forms a vSAN datastore distributed and shared across the nodes.

The vSAN software stores and manages data in the form of data containers called objects. An object is a logical volume that has its data and metadata distributed across a vSAN cluster. For example, every virtual machine disk (VMDK) is an object.

Internet small computer system interface (iSCSI) is a transport layer protocol that describes how small computer system interface (SCSI) packets are transported over a transmission control protocol/Internet protocol (TCP/IP) network. A vSAN iSCSI target (VIT) service allows hosts and physical workloads that reside outside a vSAN cluster to access the objects in a vSAN datastore using input/output (I/O) operations. The VIT service enables an iSCSI initiator on a remote host to transport block-level data to an iSCSI target on a storage device in the vSAN cluster. After enabling and configuring the VIT service on the vSAN cluster, a user can discover iSCSI targets from the remote host using the Internet protocol (IP) address of any ESXi host in the vSAN cluster and the TCP port of the iSCSI targets. To ensure high availability (HA) of the iSCSI targets and to avoid a single point of failure, the user may use the IP addresses of two or more ESXi hosts to configure multipath support iSCSI applications.

However, with some multipath configurations for distributed storage systems that use iSCSI, the multipath configuration only supports symmetrical access-all of the paths are treated as equal when servicing the I/O operations. This symmetrical access is non-optimal and results in a number of drawbacks.

### BRIEF DESCRIPTION OF DRAWINGS

FIG. 1 is a schematic diagram illustrating an example distributed storage system;

FIG. 2 is a schematic diagram illustrating example distributed storage modules of hypervisors in the system of FIG. 1;

FIG. 3 is schematic diagram illustrating an example distributed storage system having an active-active (AA) failover configuration;

FIG. 4. is a schematic diagram of a distributed storage system that can implement a resource-optimized iSCSI path selection technique based on an active-active configuration for a HCI environment;

FIG. 5 is flowchart of an iSCSI path selection method based on an active-active configuration for a HCI environment;

FIG. 6 is a flowchart of an example method to handle policy reconfiguration;

FIG. 7 is a flowchart showing an example of a method to handle data resynchronization; and

FIG. 8 is a flowchart showing an example of a method to handle object ownership transfer.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

For a distributed storage system that has an active-active configuration for hosts and such as those which use an Internet small computer system interface (iSCSI) protocol or other protocol, the present disclosure provides techniques to identify/select a plurality of paths to a target. An active optimized path is selected for a host that is an object owner, and an active non-optimized path is selected for a host that is a component owner. The selection of the optimized path for a host is further based on whether that host has sufficient processor and memory resources to service input/output for the target. A standby path is selected for any other host that is neither an object owner or a component owner. The selected paths are provided to an initiator so as to enable the initiator to choose at least one of the paths to access the target for the input/output.

### Computing Environment

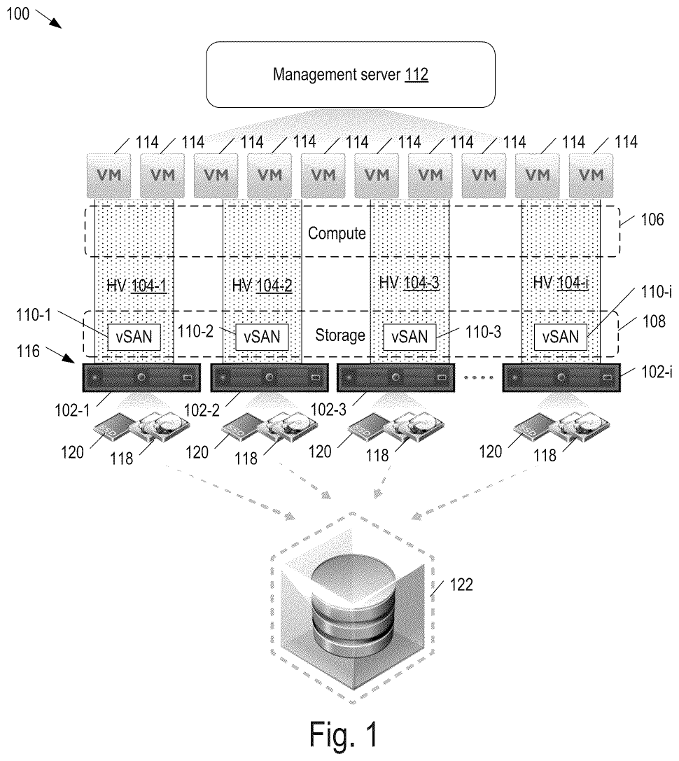

Various implementations will now be explained in more detail using FIG. 1, which is a schematic diagram illustrating an example of a distributed storage system 100. The system 100 may be provided, for example, as part of a hyperconverged infrastructure (HCI) environment. According to various embodiments, the system 100 may be implemented as a virtual storage area network (vSAN) or other analogous virtual storage arrangement that uses the Internet small computer system interface (iSCSI) protocol. Depending on the desired implementation, the system 100 may include additional and/or alternative components than that shown in FIG. 1.

For context, a vSAN using the iSCSI protocol may encompass four concepts: (1) target, (2) logical unit number (LUN), (3) discovery node (DN), and (4) storage node (SN).

A target is a container for LUNs. An initiator connects to a target and then accesses the LUNs in the target. A target is implemented as a namespace object created by vSAN software from storage in a vSAN datastore. An initiator may be an endpoint (e.g., hardware and/or software) that may be analogous to a client that establishes a session to access data storage (e.g., a target).

A LUN is a block device that can be consumed by the initiator. A LUN is implemented as a virtual machine disk (VMDK) created by the vSAN software from the vSAN datastore.

A DN is an ESXi host (e.g., a host having a hypervisor) that can act as a discovery portal for iSCSI service that an initiator may access to discover available targets. A SN is an ESXi host that can process iSCSI input/outputs (I/Os) to the LUNs within a target.

In FIG. 1, the system 100 includes host computers 102-1, 102-2, 102-3, . . . 102-i (collectively as “hosts 102” or individually as a generic “host 102”) running respective (e.g., ESXi) hypervisors 104-1, 104-2, 104-3 . . . 104-1 (collectively as “hypervisors 104” or individually as a generic “hypervisor 104”) to provide a hyper-converged compute layer 106 and a hyper-converged, distributed storage (e.g., vSAN) layer 108. Hypervisors 104-1, 104-2, 104-3, . . . 104-i include respective hyperconverged, distributed storage (e.g., vSAN) modules 110-1, 110-2, 110-3, . . . 110-i (collectively as “vSAN modules 110” or individually as a generic “vSAN module 110”) that implement vSAN layer 108. A management server 112 (e.g., vCenter) centrally provisions and manages (1) VMs 114 on the hyperconverged compute layer 106 and (2) a hyperconverged distributed (e.g., vSAN) datastore 122 on vSAN layer 108. The hosts 102 make up nodes of a hyperconverged, distributed storage (e.g., vSAN) cluster 116. The hosts 102 (nodes) contribute local storage resources (e.g., non-SSDs 118 and SSD 120) to form the vSAN datastore 122.

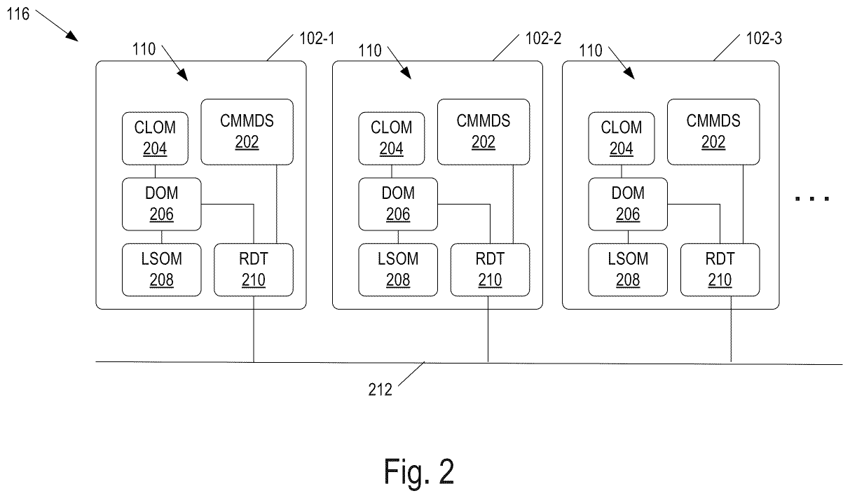

FIG. 2 is a schematic diagram illustrating the vSAN modules 110 of the hypervisors 104 in the system 100 of FIG. 1. Each vSAN module 110 includes the following components: cluster monitoring membership and directory services (CMMDS) 202, cluster level object manager (CLOM) 204, distributed object manager (DOM) 206, local log structured object management (LSOM) 208, and reliable datagram transport (RDT) 210. The CLOM 204 validates resource availability and ensures that objects are placed in the vSAN cluster 116 in a way that satisfy their storage policies, and the DOM 206 creates components and applies configuration locally through the LSOM 208. The DOM 206 also coordinates with its counterparts for component creation on other hosts 102 (nodes) in the vSAN cluster 116. All subsequent reads and writes to objects funnel through the DOM 206, which will forward them to the appropriate components. The RDT 210 is the communication mechanism for VMDK input/output (I/O) in a network 212 between the hosts 102. The RDT 210 uses transmission control protocol (TCP) at the transport layer and is responsible for creating and destroying TCP connections (sockets) on demand.

The CMMDS 202 is responsible for monitoring the vSAN cluster's membership, checking heartbeats between the hosts 102 (nodes), and publishing updates to the cluster directory. Other software components use the cluster directory to learn of changes in cluster topology and object configuration. For example, the DOM 206 uses the contents of the cluster directory to determine the hosts 202 that store the components of an object and the paths by which those hosts 202 are reachable.

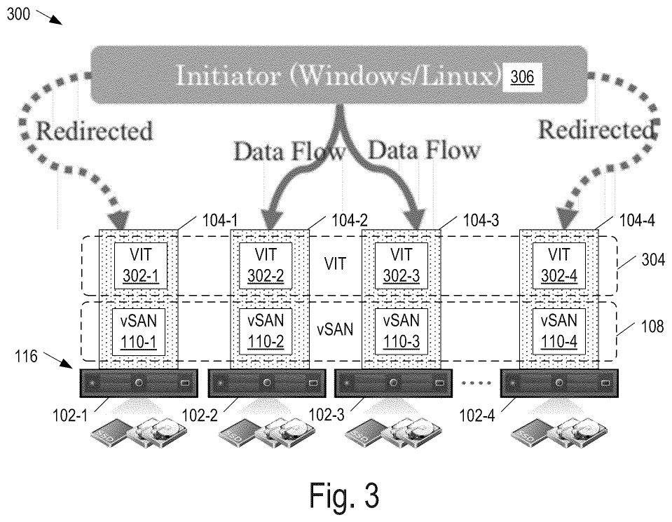

FIG. 3 is schematic diagram illustrating an example distributed storage system 300 having an active-active (AA) failover configuration. More specifically, the example system 300 has an AA failover configuration for the VIT service. Generally with an AA failover configuration, both nodes process input/output (I/O) operations, and if one of the nodes fail, the other node takes over automatically and all services may continue to run without interruption. In comparison, an active-standby failover configuration involves a first node being a primary (active) node and a second node being a standby (passive) node, in which the active node processes all of the I/O operations and synchronizes its configuration/session information with the passive node, so that in case of a failure of the first node, the second node will be ready to take over in place of the first node.

The hypervisors 104-1, 104-2, 104-3, and 104-4 include the respective vSAN modules 110-1, 110-2, 110-3, and 110-4 that implement the distributed storage layer 108. The hypervisors 104-1, 104-2, 104-3, and 104-4 also include respective iSCSI target (e.g., VIT) modules 302-1, 302-2, 302-3, and 302-4 (collectively as “VIT modules 302” or individually as a generic “VIT module 302”) that implement an iSCSI target (e.g., VIT) layer 304.

In the AA failover configuration of FIG. 3, multiple hosts simultaneously serve iSCSI inputs/outputs (I/Os) for a target. For example, the hosts 102-2 and 102-3 concurrently serve iSCSI I/Os for a target (not shown). In other words, a target has multiple SNs. Each host 102 acts as a DN for every target. If an iSCSI initiator 306 attempts to connect to a target through a non-SN of the target, the non-SN would randomly or sequentially (e.g., one after another) select one of the SNs of the target and redirect initiator 306 to the selected SN via an iSCSI redirect. For example, when the initiator 306 attempts to connect to the hosts 102-1 and 102-4 (via multipathing) for the target served by the hosts 102-2 and 102-3, the hosts 102-1 and 102-4 randomly select and redirect the initiator 306 to the hosts 102-2 and 102-3, respectively.

To take advantage of multiple SNs for a target, the initiator 306 utilizes multipathing to send I/Os through the SNs to the target. To provide data consistency in the system 300, the distributed storage layer 108 (more specifically the CMMDS 202 and the DOM 206 in the hosts 102) ensures that writes to one host 102 are immediately visible to the other hosts 102 so that each host 102 knows if it may use the data in its local storage or if it must retrieve the data from another host 102.

In some implementations, the number of SNs for a target is selected to satisfy the number of host and device failures to tolerate (FTT) for the target and its LUN. In the context of a distributed storage system such as vSAN, FTT is defined as the number of vSAN nodes that could fail while still being able to provide access to all the data that is stored in vSAN. Thus, if the target has N number of FTT, then the number of SNs for the target would be at least N+1 to guarantee fault tolerance for VIT service. When one SN fails, the initiator 306 still has at least one different path to the target through another available SN for the target.

For example, if a target's FTT is set to one (1), then it would have two duplicate components and two hosts 102 would become SNs for the target. When a target's FTT increases, the number of components as well as the number of SNs increase. For example, if a target's FTT is increased to two (2), then it would have three duplicate components and three hosts 102 would become SNs for the target.

In the AA configuration of FIG. 3, each host 102 is also a DN for all the targets in the vSan cluster 116. When processing an iSCSI discovery command, a DN in the AA configuration returns the IP addresses of all the SNs for a target. This simplifies the configuration on the initiator 306 side as the user only needs to configure a single discovery portal since each DN can respond with all the SNs for any target.

Even if a DN sends the IP addresses of all the SNs for a target to the initiator 306, the initiator 306 may sometimes connect to a non-SN because the SNs for the target may occasionally change. In this case, the non-SN redirects the initiator 306 to one of the SNs for the target.

There are some drawbacks with multipath techniques that implement symmetrical access in AA failover configurations. For example, an iSCSI target owner (e.g., a host that is an owner of the iSCSI target) may not be the same as the iSCSI LUN's backend vSAN object owner as there may be multiple LUNs under the same target. The vSAN software distributes the object owner across the cluster. With symmetrical access, all the paths are treated as being equal. However, a path to a host that is not the LUN's backend object owner will need to pass/redirect the I/O to the object owner host. This results in additional network overhead in the distributed storage system. Thus, the end-to-end I/O path is not optimized.

Another example drawback involves system resource contention caused by the selection of a path. Handling a large number of I/Os needs additional processor and memory resources. If there are insufficient CPU and memory on the host for the selected path, the I/Os will likely fail. Furthermore in a hyperconverged environment, the processor and memory are shared with other workload like VMs or containers. If the iSCSI I/Os are utilizing too many resources of the host, there may be instability for the other workloads on the host(s).

iSCSI Path Selection Based on an Active-Active Configuration

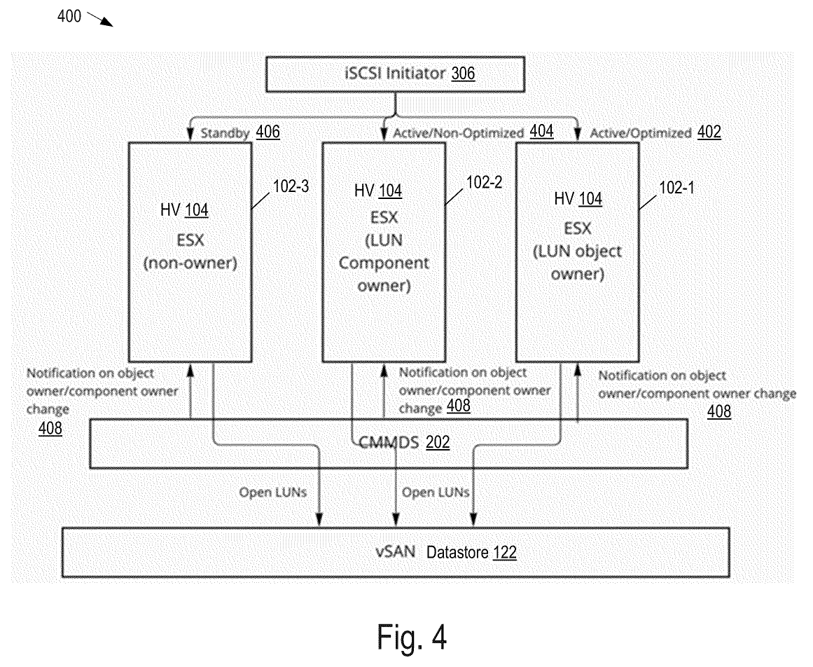

To address the above and other drawbacks, reference is made next to FIG. 4. FIG. 4 is a schematic diagram of a distributed storage system 400 that can implement a resource-optimized iSCSI path selection technique based on an active-active configuration for a HCI environment. Elements, devices, components, etc. in FIG. 4 that are similar to those shown and described above with respect to FIGS. 1-3 are labeled similarly in FIG. 4.

In the system 400, one or more of the hosts 102 (e.g., hosts 102-1, 102-2, 102-3, etc.) informs the initiator 306 as to which path (amongst multiple paths to the vSAN datastore 122) is the optimized/preferred path based on the underlying component layout for the LUNs and based on the system resources of the hosts 102.

The hosts 102 in the system 400 are identified in the example of FIG. 4 as a LUN object owner (host 102-1), a LUN component owner (host 102-2), and a non-owner (host 102-3). A LUN object owner according to various embodiments may operate analogously like a logical owner. For example, within the cluster, there is only one object owner for this LUN. This object owner coordinates all the I/Os and distributes the I/Os to different hosts based on the underlying component layout. A LUN object ownership role can transfer from host to host when appropriate. The LUN object owner (host 102-1) may be a host that is designated as the owner of the target and that does not need to introduce additional network overhead for the IO stack. From the iSCSI target layer, the LUN object owner can directly pass an I/O to the DOM 206 layer with no network transmission being needed. According to various embodiments, the LUN object owner may thus be the preferred host on an active/optimized path 402 for servicing the I/O from the iSCSI initiator 306, since the LUN object owner may provide faster and/or more efficient data access capability. For each LUN object, there is only a single LUN object owner in various embodiments.

The LUN component owner (host 102-2) may be a host on which a replica/duplicate of an object is placed. According to various embodiments, a LUN component owner is the host that holds the data replica for this LUN. For example, if the FTT=1, there are two data replicas populated on two different hosts. These two hosts are the component owners for this LUN. If a host is the LUN component owner for a specific backend vSAN object, the overhead for passing the I/Os from the VIT layer 304 to the underlying vSAN layer 108 may be small. Accordingly, the LUN component owner (host 102-2) provides an active but non-optimized (or less-optimized) path 404 as compared to the path 402 provided by the LUN's object owner (host 102-1). If a particular host 102 is the only host that serves the I/O for this specific vSAN object, various embodiments of the vSAN software transfers the object ownership to this host. Furthermore, if the current LUN object owner (host 102-1) goes down, one or more of the LUN component owners (host 102-2) becomes the new LUN object owner.

All hosts (e.g., host 102-3) that are neither a LUN object owner nor a LUN component owner are identified to the initiator 306 as providing a standby path 406. According to various embodiments, the host(s) on the standby path 406 may only handle lightweight I/O operations, such as querying for a LUN's attributions or other access to a target that is more limited relative to access provided by the active optimized and the active non-optimized paths. Substantive data read and write I/Os are not processed in the standby path 406.

In the system 400, each host 102 listens to their respective CMMDS 202 for updates (e.g., provided by a notification 408) involving both LUN object owner changes and LUN component owner changes. As will be further described below, the path selection may be updated, in response to LUN object and component owner change events and/or in response to other events.

According to various embodiments, the path selection method also takes into consideration the free/available system resources. For example, the hosts 102 in FIG. 4 also check (e.g., periodically) their respective free processor and memory, and the paths are upgraded/downgraded in response to the processor and memory resources that are determined to be available. In this manner, the selection of a path through a host, which might be heavily loaded relative to other hosts, can be avoided in favor or a less loaded host.

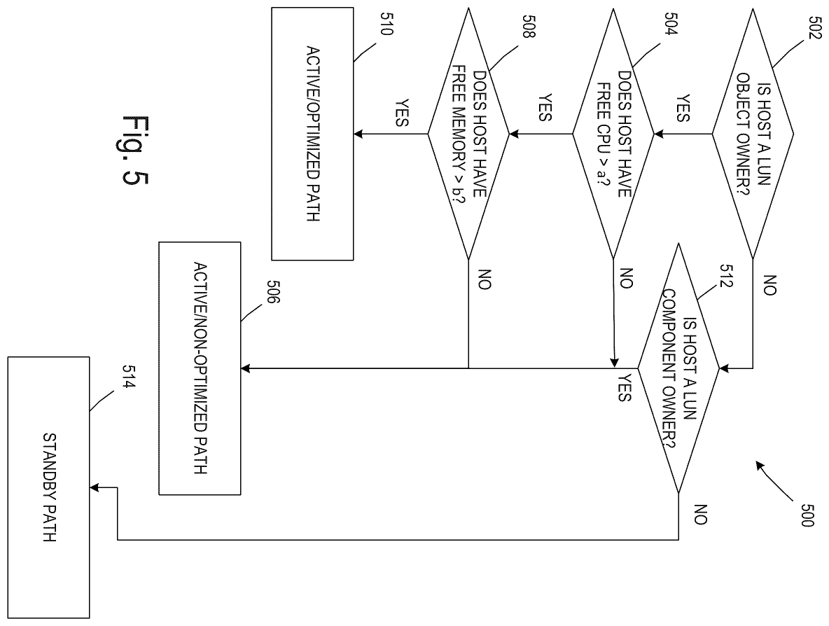

FIG. 5 is flowchart of an example iSCSI path selection method 500 based on an active-active configuration for a HCI environment. The method 500 may be performed, for example, by one or more of the hosts 102 in the system 400 of FIG. 4, so as to determine one or more paths that can be provided/recommended to an initiator 306 that is seeking to access a target through one of the hosts. According to various embodiments, each of the hosts 102 can perform the method 500 for itself, so as to determine whether that host belongs to an active optimized path, an active non-optimized path, or a standby path.

The example method 500 may include one or more operations, functions, or actions illustrated by one or more blocks, such as blocks 502 to 514. The various blocks of the method 500 and/or of any other process(es) described herein may be combined into fewer blocks, divided into additional blocks, supplemented with further blocks, and/or eliminated based upon the desired implementation. In one embodiment, the operations of the method 500 and/or of any other process(es) described herein may be performed in a pipelined sequential manner. In other embodiments, some operations may be performed out-of-order, in parallel, etc.

The method 500 may begin at a block 502 (“IS HOST A LUN OBJECT OWNER?”), in which the host 102 determines whether it is a LUN object owner (e.g., a first owner type). This determination at the block 502 may be performed, for example, in response to a request from the initiator 306 to access a target (or object). In other embodiments, the various operations of the method 500 to determine paths can be performed prior to receiving a request from the initiator to access the target (or object)

In response to determination that the host 102 is the LUN object owner (“YES” at the block 502), the host 102 determines next whether it has sufficient free central processing unit (CPU) or other processor resources and/or sufficient free memory resources to process I/Os. For example at a block 504 (“DOES HOST HAVE FREE CPU >a?”), the host 102 determines whether it has free CPU capacity greater than a threshold a. If there is insufficient CPU capacity (“NO” at the block 504), the host 102 (which is the LUN object owner) is downgraded to be on an active non-optimized path (e.g., a second path), at a block 506 (“ACTIVE/NON-OPTIMIZED PATH”).

However, if the host 102 has sufficient CPU capacity greater than the threshold a (“YES” at the block 504), then a determination is made at a block 508 (“DOES HOST HAVE FREE MEMORY>b?”) as to whether the host 102 has free memory capacity greater than a threshold b. If the host 102 has insufficient memory capacity (“NO” at the block 508), the host 102 (which is the LUN object owner) is downgraded to be on the active non-optimized path, at the block 506 (“ACTIVE/NON-OPTIMIZED PATH”).

If the host 102 has sufficient memory capacity greater than the threshold b (“YES” at the block 508), then the host 102 is marked as being on the active optimized path (e.g., a first path that is more optimized than the second path, which is the active/non-optimized path), at a block 510 (“ACTIVE/OPTIMIZED PATH”). With the active optimized path thus being determined to be at/through this host 102, all of the other hosts (which are LUN component owners) are then marked as being on the active non-optimized path, at the block 506.

With reference back to the block 502, if the host 102 is determined to not be the LUN object owner (“NO” at the block 502), then a determination is made at a block 512 (“IS HOST A LUN COMPONENT OWNER?”) as to whether the host 102 is a LUN component owner (e.g., a second owner type). If determined to be a LUN component owner (“YES” at the block 512), then the host 102 is marked as being on the active non-optimized path, at the block 506.

However, if the host is determined to not be a LUN component owner (“NO” at the block 512), then the host 102 is marked as being on a standby path (e.g., a third path), at a block 514 (“STANDBY PATH”). All hosts that are neither LUN object owners or LUN component owners (e.g., a third owner type) are marked for the standby path at the block 514.

With the hosts and the paths selected for these hosts thus being identified for a particular target (or object) based on the foregoing, this information can be provided to the initiator 306, such that when the initiator 306 seeks to access the target (or object), the initiator 306 can first choose the active optimized path as a first choice for access, and one or more of the active non-optimized path as a second choice for access. These accesses via the active optimized path and the active non-optimized path can be performed sequentially by the initiator 306, or can be performed concurrently if necessary.

With respect to the above blocks 504 and 508 of FIG. 5 to determine whether the host 102 has at least one resource that exceeds at least one threshold (e.g., whether there is sufficient free CPU and/or free memory), various techniques may be used by the host 102 to determine the thresholds a and b. According to some embodiments, the thresholds a and b may be determined using configuration settings and historical data.

The following are example formulas for determining the thresholds a and b:

$$a = \{ \begin{matrix}adminConfiguredA if a is set \\ historicalCPUUsedbyIscsi ( now - 7 days ) if a is unset \\ 0 if historicalCPUUsedbyIscsi ( now - 7 days ) not found\end{matrix} \\ b = \{ \begin{matrix}adminConfiguredB if b is set \\ historicalMemoryUsedbyIscsi ( now - 7 days ) if b is unset \\ 0 if historicalMemoryUsedbyIscsi ( now - 7 days ) not found\end{matrix}$$

According to the above example formulas, if a user (e.g., a system administrator) has configured settings for the thresholds a and b, then the host 102 uses these configured settings when performing the determinations at the blocks 504 and 508.

Otherwise if there are no configuration settings for the thresholds a and b, the host 102 checks the historical CPU and memory usage for iSCSI (e.g., usage by a iSCSI I/O service), and uses this historical usage as the thresholds a and b. For example, the host 102 may perform a look back of usage at the same time a week ago (e.g., 7 days), or any other amount of time previous to the current time. The thresholds a and b using historical data may be based on discrete usages at instances of time, average usages, or other suitable metric(s). If there is no historical usage that has been recorded, the thresholds a and b are considered as 0 in the above example formulas, as a starting basis until there is historical usage that is recorded.

### Handling LUN Policy Reconfiguration

In a HCI environment, an operation that users can perform is to change a policy for the underlying objects. An example is changing the FTT from 1 to 2 for an iSCSI LUN. This type of reconfiguration of a failure tolerance policy causes an underlying component layout change for the LUNs, such as host changes for the LUN object owner and/or the LUN component owner(s).

According to various embodiments, each host 102 may perform the example Algorithm 1 below to check for this policy reconfiguration event, and then update the path recommendations/selections accordingly in response to the policy reconfiguration event.

Algorithm 1 Handle policy reconfiguration

Input: LUN ID (lunId)
Output: Path selection for this host

| | |
|---|---|
| 1. | handle1 = SubscribeToCMMDSOnLunOwnerChange(lunId) |
| 2. | handle2 = |
| | SubscribeToCMMDSOnLunComponentOwnerChange(lunId) |
| 3. | WaitForCMMDSEventCallback(handle1, handle2) |
| 4. | newOwner = GetLunObjectOwner(lunId) |
| 5. | newComponentOwnerList = GetLunComponentOwners(lunId) |
| 6. | incompleteComponentOwnerList = |
| | GetIncompleteComponentOwners(lunId) |
| 7. | effectiveComponentOwners = |
| | newComponentOwnerList = |
| | incompleteComponentOwnerList − |
| 8. | If host == newOwner |
| 9. | If GetFreeCPU(host) > historicalCPUUsedbyIscsi(now − 7 days, |
| | default=0) |
| 10. | If GetFreeMem(host) > historicalMemUsedbyIscsi(now − 7 days, |
| | default=0) |
| 11. | Return Active/Optimized Path |
| 12. | EndIf |
| 13. | EndIf |
| 14. | Return Active/Non-Optimized Path |
| 15. | EndIf |
| 16. | If host in effectiveComponentOwners |
| 17. | Return Active/Non-Optimized Path |
| 18. | EndIf |
| 19. | Return Standby Path |

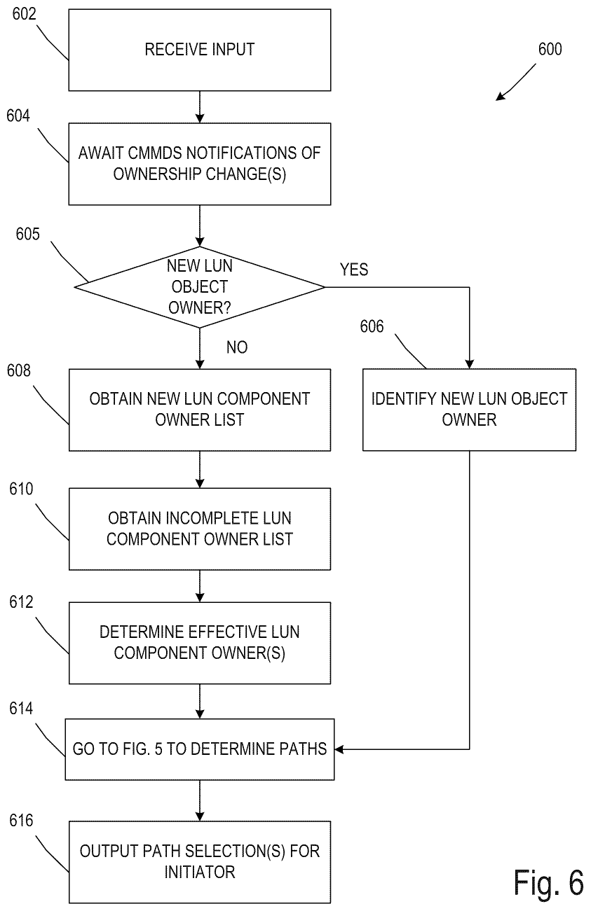

FIG. 6 shows an example of a method 600 to handle policy reconfiguration which may be performed by each host 102 in the system 400 of FIG. 4. The method 600 may be described with reference to the example Algorithm 1 above.

At a block 602 (“RECEIVE INPUT”) and a block 604 (“AWAIT CMMDS NOTIFICATIONS OF OWNERSHIP CHANGE(S)”) for a particular LUN (identified by a LUN ID), the host 102 subscribes to the CMMDS 202 so as to await and receive notifications regarding a LUN's object owner host change and component layout/ownership changes. The operations at the blocks 602 and 604 correspond to the input and lines 1-3 of Algorithm 1 above.

If the host 102 then receives a notification of one or more ownership changes, then the host 102 determines the type of ownership change, for example whether the ownership change involves a LUN object ownership change, at a block 605 (“NEW LUN OBJECT OWNER?”). If the host 102 determines that the notification involves a change in LUN object ownership (“YES” at the block 605), then the host 102 identifies the new LUN object owner and queries the new owner host for the LUN's object, at a block 606 (“IDENTIFY NEW LUN OBJECT OWNER”). If the host 102 is the new LUN object owner, the host 102 checks the free CPU and memory against the historical usage, based on the method 500 of FIG. 5, so as to determine whether this host 102 will serve as an optimized or non-optimized active path for the initiator 306, at a block 614 (“GO TO FIG. 5 TO DETERMINE PATHS”). The operations at the blocks 606 and 614 correspond to lines 4 and 8-15 of Algorithm 1 above.

If, back at the block 605, the host 102 determines that the notification is not that of a change in LUN object ownership (“NO” at the block 605) but is instead a change in LUN component ownership, then then the host 102 queries the component owners (other hosts) for the objects, so as to obtain a new list of the LUN component owners, at a block 608 (“OBTAIN NEW LUN COMPONENT OWNER LIST”). The operations at the block 608 correspond to line 5 of Algorithm 1 above.

During the policy reconfiguration period, some of the new components may not be fully ready to serve the I/Os. Accordingly in some embodiments, the host 102, also queries such components (e.g., incomplete components), at a block 610 (“OBTAIN INCOMPLETE LUN COMPONENT OWNER LIST”). The host 102 determines the effective LUN component owner(s) at a block 612 (“DETERMINE EFFECTIVE LUN COMPONENT OWNER(S)”), by excluding the incomplete LUN component owners from the list of LUN component owners for the active/non-optimized paths. The operations at the blocks 610 and 612 correspond to lines 6 and 7 of Algorithm 1 above.

If the host 102 is amongst the effective LUN component owners, then the host 102 is marked for the active non-optimized path, at the block 614. For the host(s) is/are determined at the block 614 to be neither the LUN object owner nor being amongst the effective LUN component owners, such host(s) are marked as the standby path for the initiator 306, at the block 614. Such operations at the block 614 correspond to lines 16-19 of Algorithm 1 above.

The output(s)/result(s) of the method 600 and Algorithm 1 is the identification/selection of which host for the active optimized path, which host(s) for the active non-optimized path, and which host(s) for the standby path. The host(s) can inform the initiator 306 regarding these paths that have been selected for the host(s), such as in the form of recommendation(s) provided to the initiator 306 as to which path(s) to use to access a target, at the block 616 (“OUTPUT PATH SELECTION(S) FOR INITIATOR”).

### Handling a LUN's Object Resynchronization

In a HCI environment, LUNs are usually configured to tolerate a few component failures. For example, if a LUN is configured with a policy of FTT=1, the LUN can tolerate at most one component failure. The failure could be caused by many reasons like a disk failure, a network partition, etc. After a grace/time period for trying to recover the failed component and perhaps failing, the system 400 creates a new component to resume the policy compliance. This process is called data resynchronization.

However, with resynchronization, there may not be a component layout change, but resynchronization may have an influence on the path selection. According to various embodiments, each host 102 may perform the example Algorithm 2 below to update the path recommendations/selections in response to a resynchronization event.

Algorithm 2 Handle LUN's object resync

Input: LUN ID (lunId)
Output: Updated path selection for this host

| | |
|---|---|
| 1. | IF CheckAccessibility(lunId) == inaccessible |
| 2. | Return Offline Path |
| 3. | EndIf |
| 4. | newOwner = GetLunObjectOwner(lunId) |
| 5. | newComponentOwnerList = GetLunComponentOwners(lunId) |
| 6. | incompleteComponentOwnerList = |
| | GetIncompleteComponentOwners(lunId) |
| 7. | invalidComponentOwnerList = GetInvalidComponentOwners(lunId) |
| 8. | effectiveComponentOwners = newComponentOwnerList − |
| | incompleteComponentOwnerList − invalidComponentOwnerList |
| 9. | IF host == newOwner |
| 10. | If GetFreeCPU(host) > historicalCPUUsedbyIscsi(now − 7 days, |
| | default=0) |
| 11. | If GetFreeMem(host) > |
| | historicalMemUsedbyIscsi(now − 7 days, |
| | default=0) |
| 12. | Return Active/Optimized Path |
| 13. | EndIf |
| 14. | EndIf |
| 15. | Return Active/Non-Optimized Path |
| 16. | EndIf |
| 17. | If host in effectiveComponentOwners |
| 18. | Return Active/Non-Optimized Path |
| 19. | EndIf |
| 20. | Return Standby Path |

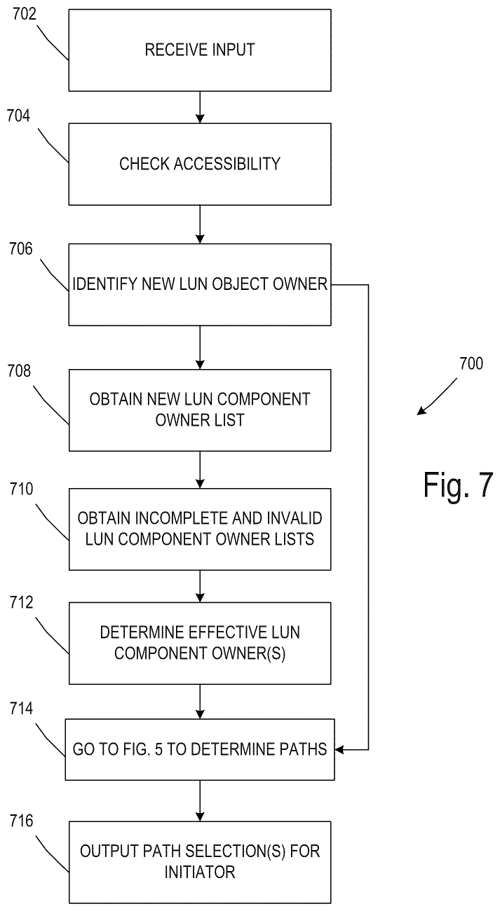

FIG. 7 shows an example of a method 700 to handle a LUN's object resynchronization which may be performed by each host 102 in the system 400 of FIG. 4. The method 700 may be described with reference to the example Algorithm 2 above.

At a block 702 (“RECEIVE INPUT”), the host 102 obtains the LUN ID involved in the resynchronization. At a block 704 (“CHECK ACCESSIBILITY”), the host 102 checks whether it can still access the LUN's object, since the data resynchronization might have been caused by a network partition. If the host 102 has lost accessibility to the LUN's object, then the path for that host will be marked as an offline path, no iSCSI commands (e.g., I/Os) should be sent through this path (including the control operations). The operations at the blocks 702 and 704 correspond to the input and lines 1-3 of Algorithm 2 above.

However, if the host 102 can still access the LUN's object, then the host checks whether the host is the new owner for the LUN object, at a block 706 (“IDENTIFY NEW LUN OBJECT OWNER”). If the host 102 is the new LUN object owner, the host 102 checks the free CPU and memory against the historical usage, based on the method 500 of FIG. 5, so as to determine whether this host 102 will serve as an optimized or non-optimized active path for the initiator 306, at a block 714 (“GO TO FIG. 5 TO DETERMINE PATHS”). The operations at the blocks 706 and 714 correspond to lines 4 and 9-16 of Algorithm 2 above.

If the host 102 is not the LUN object owner, then the host 102 obtains a new list of the LUN component owners, at a block 708 (“OBTAIN NEW LUN COMPONENT OWNER LIST”). The operations at the block 708 correspond to line 5 of Algorithm 2 above.

At a block 710 (“OBTAIN INCOMPLETE AND INVALID LUN COMPONENT OWNER LISTS”), the host 102 determines if there are any incomplete LUN component owners and also whether there are any invalid LUN component owners. For example, the invalid LUN components may include the failed components and any newly generated components that are still in data resynchronization state. The effective LUN component owner(s), which can fully serve I/Os, are determined at a block 712 (“DETERMINE EFFECTIVE LUN COMPONENT OWNER(S)”), by excluding the incomplete and invalid LUN component owners from the list of LUN component owners for the active/non-optimized paths. The operations at the blocks 710 and 712 correspond to lines 5-8 of Algorithm 2 above.

If the host 102 is amongst the effective LUN component owners, then the host 102 is marked for the active non-optimized path, at the block 714. If the host 102 is not an effective LUN component owner, then the host 102 is marked for the standby path, at the block 714. Such operations at the block 714 correspond to lines 17-20 of Algorithm 2 above.

The output(s)/result(s) of the method 700 and Algorithm 2 is an updated path selection for the host 12, by identifying whether the host 102 is on the active optimized path, the active non-optimized path, on the standby path, or the offline path. Such output(s)/result(s) can be provided as path selection(s) or recommendation(s) to the initiator 306, at the block 716 (“OUTPUT PATH SELECTION(S) FOR INITIATOR”).

### Handling LUN Object Owner Transfer

A LUN object ownership can be transferred from time to time based on a decision of the DOM 206. Once the object ownership is transferred, the path selection is also updated in various embodiments.

Each host 102 may perform the example Algorithm 3 below to update the path recommendations/selections in response to a LUN object ownership transfer event.

Algorithm 3 Handle LUN object owner transfer

Input: LUN ID (lunId), Is previous owner for this LUN (isPrevOwner)
Output: Updated path selection for this host

| | |
|---|---|
| 1. | newOwner = GetLunObjectOwner(lunId) |
| 2. | isCurrOwner = (host == newOwner) |
| 3. | currPathSelection = GetCurrentHostPathSelection( ) |
| 4. | If isPrevOwner == isCurrOwner |
| 5. | Return currPathSelection |
| 6. | EndIf |
| 7. | If isPrevOwner and not isCurrOwner |
| 8. | Return Active/Non-optimized path |
| 9. | EndIf |
| 10. | If isCurrOwner and not isPrevOwner |
| 11. | If host has enough free CPU and memory |
| 12. | Return Active/Optimized path |
| 13. | EndIf |
| 14. | Return Active/Non-optimized path |
| 15. | EndIf |

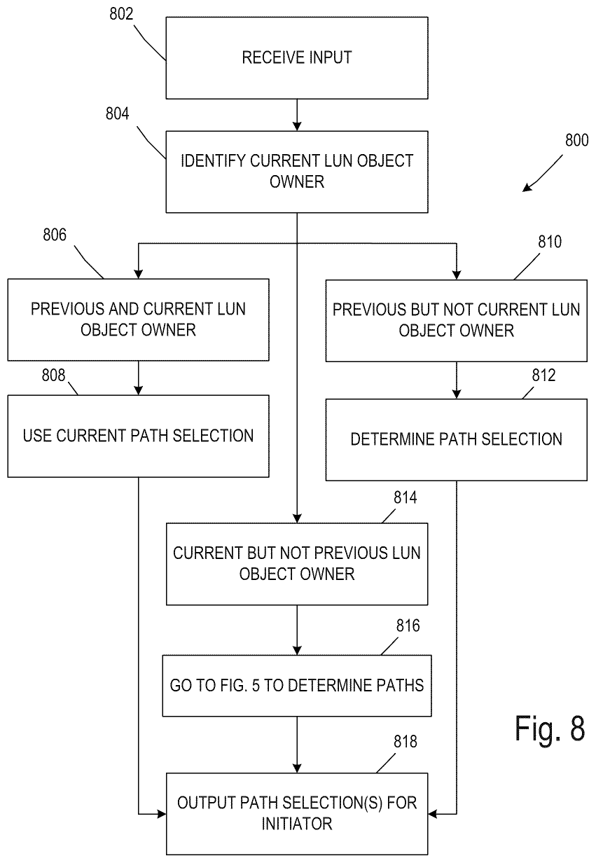

FIG. 8 shows an example of a method 800 to handle LUN object ownership changes which may be performed by each host 102 in the system 400 of FIG. 4. The method 800 may be described with reference to the example Algorithm 3 above.

At a block 802 (“RECEIVE INPUT”), the host 102 obtains the LUN ID involved in the object ownership change, and also obtains the identity of the host that was the previous LUN object owner. At a block 804 (“IDENTIFY CURRENT LUN OBJECT OWNER”), the host 102 identifies the current (new) owner as a result of the ownership transfer. The operations at the blocks 802 and 804 correspond to the inputs and line 1 of Algorithm 3 above.

What follows next in the method 800 after the block 804 is the determination as to whether the host is both the previous and current LUN object owner (e.g., no ownership transfer), whether the host is the previous LUN object owner and is not the current LUN object owner (e.g., ownership was transferred out), or whether the host is not the previous LUN object owner and is the current LUN object owner (e.g., ownership was transferred in). Such determination is represented by three branches in the method 800 of FIG. 8 after the block 804.

If the host 102 is determined to be both the previous and current LUN object owner at a block 806 (“PREVIOUS AND CURRENT LUN OBJECT OWNER”), then the current path selection is marked for the host 102 at a block 808 (“USE CURRENT PATH SELECTION”). For example, if the active and optimized path was the path selection for the host 102, then such path selection remains as the current path selection at the block 808, since there has been no LUN object ownership change. The operations at the blocks 806 and 808 correspond to lines 2-6 of Algorithm 3 above.

If the host 102 is determined to be the previous LUN object owner and is not the current LUN object owner at a block 810 (“PREVIOUS BUT NOT CURRENT LUN OBJECT OWNER”) due to the LUN object ownership being transferred out, then a determination is made for the path selection of the host 102 at a block 812 (“DETERMINE PATH SELECTION”). Such a determination at the block 812 may be made, for example, using method 600 of FIG. 6 (Algorithm 1) and method 700 of FIG. 7 (Algorithm 2). For instance, if the LUN object ownership has transferred out, the host 102 is marked as an active/non-optimized path, and if further the host 102 has lost the component for the LUN, the host is downgraded/degraded to the standby path. The operations at the blocks 810 and 812 correspond to lines 7-9 of Algorithm 3 above.

If the host 102 is determined to not be the previous LUN object owner and is the current LUN object owner at a block 814 (“CURRENT BUT NOT PREVIOUS LUN OBJECT OWNER”) due to the LUN object ownership being transferred in, then a determination is made at a block 816 (“GO TO FIG. 5 TO DETERMINE OWNERSHIPS AND PATHS”) for the path selection for the host 102. For example, the host 102 checks whether it has enough free CPU and memory using the same approach as the method 500 in FIG. 5 and/or the method 600 in FIG. 6 (Algorithm 1).

The path selection(s) from the above-described three branches of the method 500 are outputted at a block 818 (“OUTPUT PATH SELECTION(S) FOR INITIATOR”), and may be provided to the initiator 306, such as in a recommendation for using the active/optimized path as a first choice, with the active/non-optimized path(s) being a second choice, and the standby path(s) being available for limited use.

From the foregoing description, an optimized I/O path is provided to an iSCSI initiator. With the embodiments described herein, iSCSI initiators are made aware of which paths are optimized regarding the entire I/O stack including that of a distributed storage system. I/O performance is improved with reduced internal network overhead. Furthermore, system resources consumed by network transmission are also reduced.

The embodiments disclosed herein also avoid the iSCSI I/O failure caused by resource shortages. By considering the historical CPU and memory usage, paths may be dynamically downgraded or upgraded according to a host's free CPU and memory. Based on this historical usage, initiators may more likely send the I/Os to the hosts with sufficient CPU and memory resources to process the I/Os. Sending the I/Os to such hosts can avoid I/O failures caused by the resource shortage.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1 to 8.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

1. A method of selecting paths to a target in a distributed storage system having an active-active configuration, the method comprising:
determining whether a first host in the active-active configuration corresponds to a first owner type;
determining whether a second host in the active-active configuration corresponds to a second owner type;
in response to the first host being determined as corresponding to the first owner type and in response to the first host having at least one resource that exceeds at least one threshold, selecting a first path for the first host;
in response to the second host being determined as the second owner type, selecting a second path for the second host, wherein the first path is more optimized relative to the second path; and
informing an initiator of the selected first and second paths to use to access the target for input/output.

2. The method of claim 1, wherein the at least one resource includes free processor and free memory resources.

3. The method of claim 1, further comprising:
in response to the first host being determined as corresponding to the first owner type and in response to the first host having the at least one resource failing to exceed the at least one threshold, selecting the second path for the first host.

4. The method of claim 1, further comprising:
in response to the second host being determined to be a third owner type rather than the second owner type, selecting a third path for the second host, wherein the third path is a standby path that provides more limited access to the target relative to the first and second paths.

5. The method of claim 1, wherein the first owner type is associated with capability for the first host to pass the input/output to the target without using network transmission, and wherein the second owner type is associated with capability for the second host to pass the input/output to the target by using network transmission.

6. The method of claim 1, further comprising:
updating the selections of either or both the first path and the second path in response to at least one of a reconfiguration of a failure tolerance policy in the distributed storage system, a data resynchronization event in the distributed storage system, or a transfer of ownership between hosts.

7. The method of claim 1, wherein the access to the target for the input/output comprises access via an Internet small computer system interface (iSCSI) protocol.

8. A non-transitory computer-readable medium having instructions stored thereon, which in response to execution by one or more processors, cause the one or more processors to perform or control performance of a method to select paths to a target in a distributed storage system having an active-active configuration, wherein the method comprises:
determining whether a first host in the active-active configuration corresponds to a first owner type;
determining whether a second host in the active-active configuration corresponds to a second owner type;
in response to the first host being determined as corresponding to the first owner type and in response to the first host having at least one resource that exceeds at least one threshold, selecting a first path for the first host;
in response to the second host being determined as the second owner type, selecting a second path for the second host, wherein the first path is more optimized relative to the second path; and
informing an initiator of the selected first and second paths to use to access the target for input/output.

9. The non-transitory computer-readable medium of claim 8, wherein the at least one resource includes free processor and free memory resources.

10. The non-transitory computer-readable medium of claim 8, wherein the method further comprises:
in response to the first host being determined as corresponding to the first owner type and in response to the first host having the at least one resource failing to exceed the at least one threshold, selecting the second path for the first host.

11. The non-transitory computer-readable medium of claim 8, wherein the method further comprises:
in response to the second host being determined to be a third owner type rather than the second owner type, selecting a third path for the second host, wherein the third path is a standby path that provides more limited access to the target relative to the first and second paths.

12. The non-transitory computer-readable medium of claim 8, wherein the first owner type is associated with capability for the first host to pass the input/output to the target without using network transmission, and wherein the second owner type is associated with capability for the second host to pass the input/output to the target by using network transmission.

13. The non-transitory computer-readable medium of claim 8, wherein the method further comprises:
updating the selections of either or both the first path and the second path in response to at least one of a reconfiguration of a failure tolerance policy in the distributed storage system, a data resynchronization event in the distributed storage system, or a transfer of ownership between hosts.

14. The non-transitory computer-readable medium of claim 8, wherein the access to the target for the input/output comprises access via an Internet small computer system interface (iSCSI) protocol.

15. A computing device, comprising:
one or more processors; and
a non-transitory computer-readable medium coupled to the one or more processors and having instructions stored thereon which, in response to execution by the one or more processors, cause the one or more processors to perform or control performance of operations to select paths to a target in a distributed storage system having an active-active configuration, wherein the operations include:
determine whether a first host in the active-active configuration corresponds to a first owner type;
determine whether a second host in the active-active configuration corresponds to a second owner type;
in response to the first host being determined as corresponding to the first owner type and in response to the first host having at least one resource that exceeds at least one threshold, select a first path for the first host;
in response to the second host being determined as the second owner type, select a second path for the second host, wherein the first path is more optimized relative to the second path; and
inform an initiator of the selected first and second paths to use to access the target for input/output.

16. The computing device of claim 15, wherein the at least one resource includes free processor and free memory resources.

17. The computing device of claim 15, wherein the operations further include:
in response to the first host being determined as corresponding to the first owner type and in response to the first host having the at least one resource failing to exceed the at least one threshold, select the second path for the first host.

18. The computing device of claim 15, wherein the operations further include:
in response to the second host being determined to be a third owner type rather than the second owner type, selecting a third path for the second host, wherein the third path is a standby path that provides more limited access to the target relative to the first and second paths.

19. The computing device of claim 15, wherein the first owner type is associated with capability for the first host to pass the input/output to the target without using network transmission, and wherein the second owner type is associated with capability for the second host to pass the input/output to the target by using network transmission.

20. The computing device of claim 15, wherein the operations further include:
update the selections of either or both the first path and the second path in response to at least one of a reconfiguration of a failure tolerance policy in the distributed storage system, a data resynchronization event in the distributed storage system, or a transfer of ownership between hosts.

21. The computing device of claim 15, wherein the access to the target for the input/output comprises access via an Internet small computer system interface (iSCSI) protocol.
